(19) United States
(12) Patent Application Publication
(10) Pub. No.: US 2025/0250463 A1
(43) Pub. Date: Aug. 7, 2025

(54) Flexible Paper Coating Formulation

(71) Applicant: ExxonMobil Technology and Engineering Company, Spring, TX (US)

(72) Inventors: Madelyn Bekker, Humble, TX (US); James N. Coffey, League City, TX (US); Bryniqua L. Payne, Houston, TX (US); Toni Massoud, Port-Jérôme-sur-Seine (FR); Ophelie J. Duhamel, Corneville-sur-risle (FR)

(73) Assignee: ExxonMobil Technology and Engineering Company, Spring, TX (US)

(21) Appl. No.: 19/011,846

(22) Filed: Jan. 7, 2025

Related U.S. Application Data
(60) Provisional application No. 63/549,882, filed on Feb. 5, 2024.

(51) Int. Cl. C09D 191/06; B32B 29/00; B32B 29/06; B32B 29/08; C09D 7/65; D21H 19/18; D21H 19/22; D21H 27/10

(52) U.S. Cl. CPC C09D 191/06; B32B 29/005; B32B 29/06; B32B 29/08; C09D 7/65; D21H 19/18; D21H 19/22; D21H 27/10; B32B 2250/26; B32B 2255/12; B32B 2255/24; B32B 2255/26; B32B 2307/546; B32B 2439/00

(57) ABSTRACT

A flexible packaging may include a flexible material; and a protective coating disposed on the flexible material, wherein the protective coating comprises: a fully refined paraffin wax comprising straight chain normal paraffin hydrocarbons in an amount of about 60 wt. % or more by weight of the fully refined paraffin wax, wherein the fully refined paraffin wax has a melting point in a range of about 68.5° C. to about 73.5° C. as measured according to ASTM D87-09(2018); and a propylene elastomer in an amount of at least about 3 wt. % of the protective coating wherein the propylene elastomer comprises isotactic propylene repeat units copolymerized with ethylene and/or a C₄-C₁₀ α-olefin in an amount of about 1 mol. % to about 35 mol. %.

### FIELD

This application relates to flexible packaging, and more particularly, example embodiments relate to a protective coating composition comprising a fully refined paraffin wax and a propylene elastomer.

### BACKGROUND

Flexible packaging refers to a type of packaging that is made from flexible materials and a protective coating disposed on the flexible material. Flexible materials can include composite materials, plastic films, metal foils, and paper packaging such as cardboard and paperboard. Flexible packaging is used in various industries to package a wide range of products such as food, personal products, pharmaceuticals, consumer goods, and more. The protective coating is engineered to protect the contents of the flexible packaging from moisture, oxygen, light, and other external factors that can degrade product quality. The materials used in the protective coating can be selected to provide specific levels of protection, such as high barrier films for oxygen-sensitive products or UV-blocking films for light-sensitive items.

Wax is commonly used as a component of the protective coating to block gases, water vapor, odors, light, and flavors from penetrating the flexible packaging. In curtain coating methods, the equipment used to apply the protective coating generates a molten “curtain” of liquid that falls onto the flexible material which is allowed to cure to form the protective coating. The molten liquid can include petroleum wax, ethylene vinyl acetate polymer plasticizer, and a hydrocarbon resin tackifier to increase the adhesion of the coating mixture to the flexible material. Flexible packaging requires flexibility in the protective coating to accommodate movement of the final packaging. While ethylene vinyl acetate polymer plasticizer is appropriate for some applications, the ethylene vinyl acetate polymer may not have the flexibility required in folding carton applications where folding may crack and deteriorate the protective coating.

### SUMMARY

Disclosed herein is an example flexible packaging including: a flexible material; and a protective coating disposed on the flexible material, wherein the protective coating comprises: a fully refined paraffin wax comprising straight chain normal paraffin hydrocarbons in an amount of about 60 wt. % or more by weight of the fully refined paraffin wax, wherein the fully refined paraffin wax has a melting point in a range of about 68.5° C. to about 73.5° C. as measured according to ASTM D87-09(2018); and a propylene elastomer in an amount of at least about 3 wt. % of the protective coating wherein the propylene elastomer comprises isotactic propylene repeat units copolymerized with ethylene and/or a C₄-C₁₀ α-olefin in an amount of about 1 mol. % to about 35 mol. %.

Further disclosed herein is an example method for producing a flexible packaging including: depositing a protective coating on a flexible material, wherein the protective coating comprises: a fully refined paraffin wax comprising straight chain normal paraffin hydrocarbons in an amount of about 60 wt. % or more by weight of the fully refined paraffin wax, wherein the fully refined paraffin wax has a melting point in a range of about 68.5° C. to about 73.5° C. as measured according to ASTM D87-09(2018); and a propylene elastomer in an amount of at least about 3 wt. % of the protective coating wherein the propylene elastomer comprises isotactic propylene repeat units copolymerized with ethylene and/or a C₄-C₁₀ α-olefin in an amount of about 1 mol. % to about 35 mol. %.

Further disclosed herein is an example composition for producing a protective coating on a flexible material including: a fully refined paraffin wax comprising straight chain normal paraffin hydrocarbons in an amount of about 60 wt. % or more by weight of the fully refined paraffin wax, wherein the fully refined paraffin wax has a melting point in a range of about 68.5° C. to about 73.5° C. as measured according to ASTM D87-09(2018); and a propylene elastomer in an amount of at least about 3 wt. % of the protective coating wherein the propylene elastomer comprises isotactic propylene repeat units copolymerized with ethylene and/or a C₄-C₁₀ α-olefin in an amount of about 1 mol. % to about 35 mol. %.

These and other features and attributes of the disclosed materials, methods, and compositions of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1 is an illustrative depiction of a corrugated sheet including a protective coating composition in accordance with certain embodiments of the present disclosure.

FIG. 2 is a graph of results of a water absorption test for a plurality of protective coating compositions in accordance with certain embodiments of the present disclosure.

FIG. 3 is a graph of results of an edge crush test for a plurality of protective coating compositions in accordance with certain embodiments of the present disclosure.

FIG. 4 is a graph of results of a corrugated fiberboard determination of edgewise crush resistance for a plurality of protective coating compositions in accordance with certain embodiments of the present disclosure.

### DETAILED DESCRIPTION

Disclosed herein is flexible packaging, and more particularly, example embodiments relate to flexible packaging which includes a protective coating composition comprising a fully refined paraffin wax and a propylene elastomer. The disclosed protective coating composition further has unexpectedly high flexibility for the degree of crystallinity of the fully refined paraffin wax and has superior flexibility as compared to protective coating compositions which include wax and ethylene vinyl acetate polymer plasticizer.

### Protective Coating Composition

In embodiments, protective coating compositions include a fully refined paraffin wax, a propylene elastomer, and optional additives. The protective coating compositions disclosed herein are useful in curtain coating applications, cascade coating applications, saturating coating applications, and impregnating coating applications.

### Wax

Paraffin waxes are petroleum-derived, primarily from solvent de-waxing of lubricant basestocks. After separation of lubricant basestocks, the waxes obtained typically have an oil content of from about 5.0 wt. % to about 50.0 wt. % and are considered slack wax or “high” oil content wax. These high oil content waxes may be further de-oiled to a paraffin wax having an oil content of about 1.0 wt. % to about 5.0 wt. % i.e., “semi-refined” or “scale wax.” Further refinement may result in a “fully refined” paraffin wax having less than about 1.0 wt. % oil content.

In embodiments, the fully refined paraffin wax is included in the protective coating compositions in an amount of 10 wt. % to 99 wt. % by weight of the protective coating composition. Alternatively in embodiments, the fully refined paraffin wax is included in the protective coating compositions in an amount of 10 wt. % to 25 wt. %, 25 wt. % to 50 wt. %, 50 wt. % to 75 wt. %, 75 wt. % to 99 wt. %, or any ranges therebetween.

The fully refined paraffin wax is primarily comprised of straight chain normal paraffin hydrocarbons. In embodiments, the fully refined paraffin wax includes greater than 60 wt. % straight chain normal paraffin hydrocarbons, alternatively, greater than 62 wt. % straight chain normal paraffin hydrocarbons, or alternatively, greater than 65 wt. % straight chain normal paraffin hydrocarbons. In embodiments, the fully refined paraffin wax includes molecules with carbon numbers from 20 carbon atoms to 70 carbon atoms. Alternatively in embodiments, from 20 carbon atoms to 50 carbon atoms, 50 carbon atoms to 70 carbon atoms, or any ranges therebetween.

In embodiments, the fully refined paraffin wax has a melting point in a range of 68.5° C. to 73.5° C. as measured according to ASTM D87-09(2018). Alternatively in embodiments, the fully refined paraffin wax has a melting point in a range of 68.9° C. to 73.3° C., 69.5° C. to 72.5° C., 70° C. to 72° C., or any ranges therebetween.

In embodiments, the fully refined paraffin wax has an oil content of less than 0.8 wt. % as measured according to ASTM D721-17. Alternatively in embodiments, the fully refined paraffin wax has an oil content of less than 0.75 wt. %, less than 0.6 wt. %, or less than 0.5 wt. %.

In embodiments, the fully refined paraffin wax has a flash point (Cleveland open cup) in a range of 215° C. to 225° C. as measured according to ASTM D92-18. Alternatively in embodiments, the fully refined paraffin wax has a flash point (Cleveland open cup) in a range of 218° C. to 222° C.

In embodiments, the fully refined paraffin wax has a kinematic viscosity at 100° C. (KV100) in a range of 4.5 mm²/s to 7.0 mm²/s as measured according to ASTM D445-23. Alternatively in embodiments, the fully refined paraffin wax has a kinematic viscosity at 100° C. (KV100) in a range of 5 mm²/s to 7.5 mm²/s.

In embodiments, the fully refined paraffin wax has a needle pen test penetration at 25° C. in a range of 15 mm to 17 mm as measured according to ASTM D1321-16a. Alternatively in embodiments, the fully refined paraffin wax has a needle pen test penetration at 25° C. in a range of 16 mm to 18 mm.

In embodiments, the fully refined paraffin wax has a number average molecular weight of about 475 g/mol to about 495 g/mol. Alternatively, the fully refined paraffin wax has a number average molecular weight of about 475 g/mol to about 480 g/mol, about 480 g/mol to about 485 g/mol, about 485 g/mol to about 490 g/mol, about 490 g/mol to about 495 g/mol, or any ranges therebetween.

In embodiments, the fully refined paraffin wax has a weight average molecular weight of about 505 g/mol to about 525 g/mol. Alternatively, the fully refined paraffin wax has a weight average molecular weight of about 505 g/mol to about 510 g/mol, about 510 g/mol to about 515 g/mol, about 515 g/mol to about 520 g/mol, about 520 g/mol to about 525 g/mol, or any ranges therebetween.

### Propylene Elastomer

In embodiments, propylene elastomer can be a copolymer of propylene-derived units and comonomer units derived from at least one of ethylene or a C₄-C₁₀ α-olefin. The propylene elastomer may contain at least about 50 mol. % propylene-derived units. The propylene elastomer may have limited crystallinity due to adjacent isotactic propylene units and a melting point as described herein. The crystallinity and the melting point of the propylene elastomer can be reduced compared to highly isotactic polypropylene by the introduction of errors in the insertion of propylene. The propylene-based elastomer is generally devoid of any substantial intermolecular heterogeneity in tacticity and comonomer composition, and also generally devoid of any substantial heterogeneity in intramolecular composition distribution.

In embodiments, the amount of propylene-derived units present in the propylene elastomer may range from an upper limit of about 95 mol. %, about 94 mol. %, about 92 mol. %, about 90 mol. %, or about 85 mol. %, to a lower limit of about 60 mol. %, about 65 mol. %, about 70 mol. %, about 75 mol. %, about 80 mol. %, about 84 mol. %, or about 85 mol. % of the propylene elastomer.

In embodiments, the comonomer units included in the propylene elastomer include at least one of ethylene and/or a C₄-C₁₀ α-olefin. The comonomer units may be present in the propylene elastomer in an amount of about 1 mol. % to about 35 mol. %, or about 5 mol. % to about 35 mol. %, or about 7 mol. % to about 32 mol. %, or about 8 mol. % to about 25 mol. %, or about 8 mol. % to about 20 mol. %, or about 8 mol. % to about 18 mol. %, of the propylene elastomer. The comonomer content may be adjusted so that the propylene elastomer has a heat of fusion of less than about 80 J/g, a melting point of about 105° C. or less, and a crystallinity of about 2% to about 65% of the crystallinity of isotactic polypropylene, and a melt flow rate (MFR) of about 2 to about 20 g/min.

In some embodiments, the comonomer includes ethylene, 1-hexene, and/or 1-octene. In embodiments where the propylene elastomer includes ethylene-derived units, the propylene-based elastomer may include about 5 mol. % to about 25 mol. %, or about 8 mol. % to about 20 mol. %, or about 9 mol. % to about 16 mol. %, ethylene-derived units. In some embodiments, the propylene elastomer includes units derived from propylene and ethylene and the propylene-based elastomer does not contain any other comonomer in an amount other than that typically present as impurities in the ethylene and/or propylene feedstreams used during polymerization, or in an amount that would materially affect the heat of fusion, melting point, crystallinity, or melt flow rate of the propylene-based elastomer, or in an amount such that any other comonomer is intentionally added to the polymerization process.

In some embodiments, the propylene elastomer may include more than one comonomer. Some embodiments of a propylene elastomer having more than one comonomer include propylene-ethylene-octene, propylene-ethylene-hexene, and propylene-ethylene-butene polymers. In embodiments where more than one comonomer derived from at least one of ethylene or a C₄-C₁₀ α-olefin is present, the amount of one comonomer may be less than about 5 mol. % of the propylene-based elastomer, but the combined amount of comonomers of the propylene-based elastomer is about 5 mol. % or greater.

In embodiments the propylene elastomer further includes diene-derived units including hydrocarbon structures having at least two unsaturated bonds wherein at least one of the unsaturated bonds is readily incorporated into a polymer. Examples dienes may include, but are not limited to, straight chain acyclic olefins, such as 1,4-hexadiene and 1,6-octadiene; branched chain acyclic olefins, such as 5-methyl-1,4-hexadiene, 3,7-dimethyl-1,6-octadiene, and 3,7-dimethyl-1,7-octadiene; single ring alicyclic olefins, such as 1,4-cyclohexadiene, 1,5-cyclooctadiene, and 1,7-cyclododecadiene; multi-ring alicyclic fused and bridged ring olefins, such as tetrahydroindene, norbornadiene, methyl-tetrahydroindene, dicyclopentadiene, bicyclo-(2.2.1)-hepta-2,5-diene, norbornadiene, alkenyl norbornenes, alkylidene norbornenes, e.g., ethylidiene norbornene (“ENB”), cycloalkenyl norbornenes, and cycloalkylidene norbornenes (such as 5-methylene-2-norbornene, 5-ethylidene-2-norbornene, 5-propenyl-2-norbornene, 5-isopropylidene-2-norbornene, 5-(4-cyclopentenyl)-2-norbornene, 5-cyclohexylidene-2-norbornene, 5-vinyl-2-norbornene); and cycloalkenyl-substituted alkenes, such as vinyl cyclohexene, allyl cyclohexene, vinyl cyclooctene, 4-vinyl cyclohexene, allyl cyclodecene, vinyl cyclododecene, tetracyclo (A-11,12)-5,8-dodecene, and combinations thereof. The amount of diene-derived units included in the propylene elastomer may range from an upper amount of about 15%, about 10%, about 7%, about 5%, about 4.5%, about 3%, about 2.5%, or about 1.5%, to a lower amount of about 0%, about 0.1%, about 0.2%, about 0.3%, about 0.5%, about 1%, about 3%, or about 5%, based on the total weight of the propylene elastomer.

The propylene elastomer may have a triad tacticity of three propylene units, as measured by 13C NMR, of at least about 75%, at least about 80%, at least about 82%, at least about 85%, or at least about 90%. In at least one embodiment, the propylene elastomer has a triad tacticity of about 50% to about 99%, or about 60% to about 99%, or about 75% to about 99%, or about 80 to about 99%. In some embodiments, the propylene elastomer may have a triad tacticity of about 60 to 97%.

In embodiments, the propylene elastomer has a heat of fusion (“Hf”), as determined by differential scanning calorimetry (DSC), of about 80 J/g or less, or about 70 J/g or less, or about 50 J/g or less, or about 40 J/g or less. The propylene elastomer may have a lower limit Hf of about 0.5 J/g, or about 1 J/g, or about 5 J/g. For example, the Hf value may range from about 1 J/g, 1.5 J/g, 3 J/g, 4 J/g, 6 J/g, or 7 J/g, to about 30 J/g, 35 J/g, 40 J/g, 50 J/g, 60 J/g, 70 J/g, 75 J/g, or 80 J/g.

The propylene elastomer may have a percent crystallinity, as determined according to the DSC procedure described herein, of about 2% to about 65%, or about 0.5% to about 40%, or about 1% to about 30%, or about 5% to about 35%, of the crystallinity of isotactic polypropylene. The thermal energy for the highest order of propylene (i.e., 100% crystallinity) is estimated at 189 J/g. In some embodiments, the copolymer has crystallinity less than 40%, or in the range of about 0.25% to about 25%, or in the range of about 0.5% to about 22% of the crystallinity of isotactic polypropylene.

Embodiments of the propylene-based elastomer may have a tacticity index (m/r) (as determined by 13C NMR) from about 4, or about 6, to about 8, or about 10, or about 12. In some embodiments, the propylene-based elastomer has an isotacticity index (as determined by 13C NMR) greater than 0%, or within the range having an upper limit of about 50%, or about 25%, and a lower limit of about 3%, or about 10%.

The propylene elastomer may have a single peak melting transition as determined by DSC. In some embodiments, the propylene elastomer has a primary peak transition of about 90° C. or less, with a broad end-of-melt transition of about 110° C. or greater. The peak “melting point” (“Tm”) is defined as the temperature of the greatest heat absorption within the range of melting of the sample. However, the propylene elastomer may show secondary melting peaks adjacent to the principal peak, and/or at the end-of-melt transition. For the purposes of this disclosure, such secondary melting peaks are considered together as a single melting point, with the highest of these peaks being considered the Tm of the propylene elastomer. The propylene elastomer may have a Tm of about 110° C. or less, about 105° C. or less, about 100° C. or less, about 90° C. or less, about 80° C. or less, or about 70° C. or less. In some embodiments, the propylene-based elastomer has a Tm of about 25° C. to about 105° C., or about 60° C. to about 105° C., or about 70° C. to about 105° C., or about 90° C. to about 105° C.

In embodiments, the propylene-based elastomer has a density of about 0.850 g/cm3 to about 0.900 g/cm3, or about 0.860 g/cm3 to about 0.880 g/cm3, at room temperature as measured per ASTM D1505.

In embodiments, the propylene elastomer has a melt flow rate (“MFR”), as measured per ASTM D1238, 2.16 kg at 230° C., of at least about 2 g/10 min. In some embodiments, the propylene-based elastomer may have an MFR of about 2 g/10 min to about 1500 g/10 min, or about 2 g/10 min to about 1000 g/10 min, or about 2 g/10 min to about 500 g/10 min. In certain embodiments, the propylene elastomer has a Brookfield viscosity between 300 Centipoise to 300000 Centipoise as measured at 190 C.

In embodiments, the propylene elastomer has an Elongation at Break of about 2000% or less, about 1800% or less, about 1500% or less, about 1000% or less, or about 800% or less, as measured per ASTM D412.

In embodiments, the propylene elastomer has a weight average molecular weight (Mw) of about 5,000 g/mol to about 5,000,000 g/mol, or about 10,000 g/mol to about 1,000,000 g/mol, or about 50,000 g/mol to about 400,000 g/mol. In embodiments, the propylene elastomer has a number average molecular weight (Mn) of about 2,500 g/mol to about 250,000 g/mol, or about 10,000 g/mol to about 250,000 g/mol, or about 25,000 g/mol to about 250,000 g/mol. In embodiments, the propylene elastomer has a z-average molecular weight (Mz) of about 10,000 g/mol to about 7,000,000 g/mol, or about 80,000 g/mol to about 700,000 g/mol, or about 100,000 g/mol to about 500,000 g/mol.

In embodiments, the propylene elastomer has a molecular weight distribution (“MWD”) of about 1.5 to about 20, or about 1.5 to about 15, or about 1.5 to about 5, or about 1.8 to about 3, or about 1.8 to about 2.5.

The propylene elastomer is included in the protective coating compositions in minimum amount of about 3 wt. % to about 50 wt. % by weight of the protective coating composition. Alternatively in embodiments, the propylene elastomer is included in the protective coating compositions in an amount of 3 wt. % to 10 wt. %, 10 wt. % to 25 wt. %, 25 wt. % to 40 wt. %, 40 wt. % to 50 wt. %, or any ranges therebetween.

### Additives

In embodiments, the protective coating composition further comprises a tackifier which increases adhesion between the flexible materials and the protective coating disposed on the flexible material in the flexible packaging. Suitable tackifiers may include, but are not limited to, rosins, glycerol and pentaerythritol esters of rosins, phenolic-modified pentaerythritol ester of rosin; styrene/terpene, alpha methyl styrene/terpene, aliphatic olefin derived resins including diene-olefin copolymer of piperylene and 2-methyl-2-butene, cycloaliphatic hydrocarbon resins, and combinations thereof. In embodiments, the tackifier is present in an amount of 1 wt. % to 30 wt. % of the protective coating composition. Alternatively in embodiments, the tackifier is present in an amount of 1 wt. % to 10 wt. % of the protective coating composition. Alternatively in embodiments, the tackifier is present in an amount of 10 wt. % to 20 wt. % of the protective coating composition. Alternatively in embodiments, the tackifier is present in an amount of 20 wt. % to 30 wt. % of the protective coating composition.

In embodiments, the protective coating composition further comprises microcrystalline wax. Microcrystalline wax is petroleum-derived was which is characterized by small and tightly packed crystal structure. Microcrystalline wax is typically contains paraffins, iso-paraffins, and cyclic compounds with carbon atoms in the range of C25 to C100 or higher. The degree of branching prevents microcrystalline waxes from forming relatively large crystals and can impart desirable properties to the protective coating such as increasing the texture softness and imparting flexibility. In embodiments, microcrystalline wax is included in the protective coating composition in an amount of 3 wt. % to 50 wt. % of the protective coating composition. Alternatively in embodiments, microcrystalline wax is included in the protective coating composition in an amount of 3 wt. % to 10 wt. % of the protective coating composition. Alternatively in embodiments, microcrystalline wax is included in the protective coating composition in an amount of 10 wt. % to 25 wt. % of the protective coating composition. Alternatively in embodiments, microcrystalline wax is included in the protective coating composition in an amount of 25 wt. % to 50 wt. % of the protective coating composition.

In embodiments, the protective coating composition further comprise a melting point modifier and/or hardness modifier. Some non-limiting examples include Fischer-Tropsch wax, polyethylene wax, and combinations thereof. In embodiments, a melting point modifier and/or hardness modifier is included in the protective coating composition in an amount of 3 wt. % to 50 wt. % of the protective coating composition. Alternatively in embodiments, a melting point modifier and/or hardness modifier is included in the protective coating composition in an amount of 3 wt. % to 10 wt. % of the protective coating composition. Alternatively in embodiments, a melting point modifier and/or hardness modifier is included in the protective coating composition in an amount of 10 wt. % to 25 wt. % of the protective coating composition. Alternatively in embodiments, a melting point modifier and/or hardness modifier is included in the protective coating composition in an amount of 25 wt. % to 50 wt. % of the protective coating composition.

### Methods of Use

Flexible packaging is made from a flexible material and a protective coating disposed on the flexible material. In embodiments, the protective coating composition is applied to the flexible material a by curtain coating equipment such as a pressure head coater and/or a weir type coater. In the curtain coating method, the protective coating composition is heated until molten and a flexible material is passed through a falling curtain formed by the molten protective coating composition such that the protective coating composition is applied to the flexible material. In further embodiments, the protective coating composition is applied to the flexible material a roll coating, involves applying the protective coating composition onto the substrate using engraved rollers. The protective coating composition is transferred from the cells of the engraved roller onto the substrate by contacting the roller and substrate. In further embodiments, the protective coating composition is applied to the flexible material by flexographic printing where an anilox roller with cells of a specific volume is used to transfer the protective coating composition onto a transfer roller or directly onto the substrate. In further embodiments, the protective coating composition is applied to the flexible material by extrusion coating. Extrusion coating involves applying a molten protective coating composition layer onto the substrate using an extrusion die. The protective coating composition is melted and forced through a slot die onto the moving substrate, creating a continuous coating. In embodiments the protective coating composition is applied to the substrate by spray coating. Spray coating involves atomizing the protective coating composition into fine droplets and spraying the atomized protective coating composition onto the substrate. In further embodiments, the protective coating composition is applied to the substrate by hot melt coating. Hot melt coating involves applying a molten protective coating composition directly onto the substrate using a heated roller or applicator. The molten protective coating composition is transferred onto the substrate, and then the excess protective coating composition is removed through doctor blades or other mechanisms. In further embodiments, the protective coating composition is applied to the substrate by slot die coating. Slot die coating involves using a narrow slot die to apply a controlled and uniform layer of the protective coating composition is applied to the substrate by onto the substrate. The protective coating composition is applied to the substrate by is pumped through the slot die which forms a coating bead which in then pressed onto the substrate. The formulations described herein may also be applied by other methods, such as saturating, cascade, impregnating, wet or dry process roll or bar coating.

In embodiments, the protective coating composition is applied to a suitable substrate. Suitable substrates may include, but are not limited to, paper, paperboard, corrugated cardboard, corrugated box stock, films, foils, metals, composite materials, textiles, and combinations thereof.

### Flexible Packaging

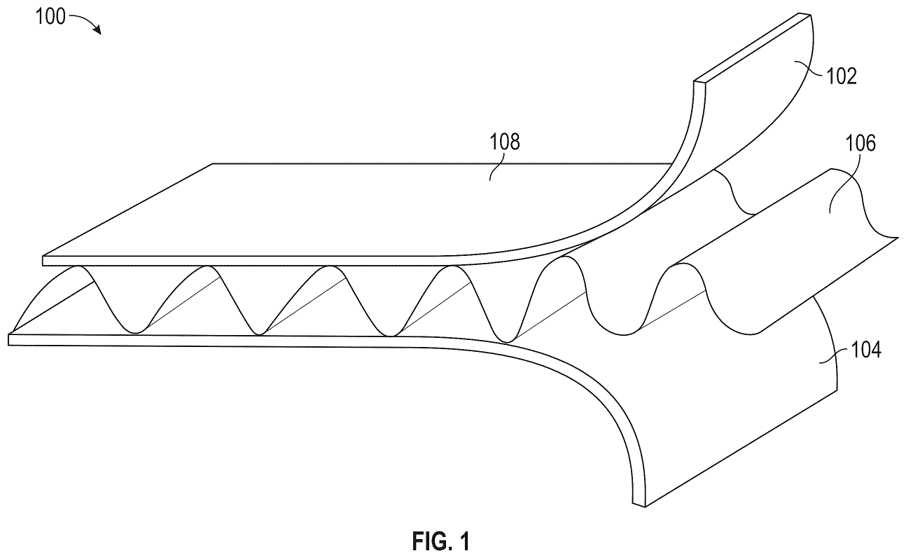

FIG. 1 is an illustrative depiction of a corrugated sheet 100 including a protective coating composition in accordance with certain embodiments of the present disclosure. Corrugated sheet 100 includes a top sheet 102, a bottom sheet 104, and a corrugated sheet 106, sandwiched between top sheet 102 and bottom sheet 104. A protective coating 108 is disposed on top sheet 102, and optionally bottom sheet 104. Protective coating 108 can include those protective coating compositions described herein.

### Additional Embodiments

Accordingly, the present disclosure may provide flexible packaging, and more particularly, methods and compositions of flexible packaging which includes a protective coating composition comprising a fully refined paraffin wax and a propylene elastomer. The methods and compositions may include any of the various features disclosed herein, including one or more of the following statements.

Embodiment 1. A flexible packaging comprising: a flexible material; and a protective coating disposed on the flexible material, wherein the protective coating comprises: a fully refined paraffin wax comprising straight chain normal paraffin hydrocarbons in an amount of about 60 wt. % or more by weight of the fully refined paraffin wax, wherein the fully refined paraffin wax has a melting point in a range of about 68.5° C. to about 73.5° C. as measured according to ASTM D87-09(2018); and a propylene elastomer in an amount of at least about 3 wt. % of the protective coating wherein the propylene elastomer comprises isotactic propylene repeat units copolymerized with ethylene and/or a C₄-C₁₀ α-olefin in an amount of about 1 mol. % to about 35 mol. %.

Embodiment 2. The flexible packaging of embodiment 1 wherein the flexible material comprises at least one material selected from the group consisting of paper, paperboard, corrugated cardboard, corrugated box stock, a film, a foil, a metal, a composite material, a textile, and combinations thereof.

Embodiment 3. The flexible packaging of any of embodiments 1-2 wherein the fully refined paraffin wax comprises molecules with carbon numbers from about 20 carbon atoms to about 70 carbon atoms.

Embodiment 4. The flexible packaging of any of embodiments 1-3 wherein the fully refined paraffin wax has an oil content of less than about 0.8 wt. % as measured according to ASTM D721-17.

Embodiment 5. The flexible packaging of any of embodiments 1-4 wherein the fully refined paraffin wax has a flash point (Cleveland open cup) in a range of about 215° C. to about 225° C. as measured according to ASTM D92-18.

Embodiment 6. The flexible packaging of any of embodiments 1-5 wherein the fully refined paraffin wax has a kinematic viscosity at 100° C. (KV100) in a range of about 4.5 mm2/s to 7.0 mm2/s as measured according to ASTM D445-23.

Embodiment 7. The flexible packaging of any of embodiments 1-6 wherein the fully refined paraffin wax has a needle pen test penetration at 25° C. in a range of about 15 mm to about 17 mm as measured according to ASTM D1321-16a.

Embodiment 8. The flexible packaging of any of embodiments 1-7 wherein the fully refined paraffin wax has a needle pen test penetration at 25° C. in a range of about 16 mm to about 18 mm as measured according to ASTM D1321-16a.

Embodiment 9. The flexible packaging of any of embodiments 1-8 wherein the fully refined paraffin wax has a number average molecular weight of about 475 g/mol to about 495 g/mol and has a weight average molecular weight of about 505 g/mol to about 525 g/mol.

Embodiment 10. A method for producing a flexible packaging comprising: depositing a protective coating on a flexible material, wherein the protective coating comprises: a fully refined paraffin wax comprising straight chain normal paraffin hydrocarbons in an amount of about 60 wt. % or more by weight of the fully refined paraffin wax, wherein the fully refined paraffin wax has a melting point in a range of about 68.5° C. to about 73.5° C. as measured according to ASTM D87-09(2018); and a propylene elastomer in an amount of at least about 3 wt. % of the protective coating wherein the propylene elastomer comprises isotactic propylene repeat units copolymerized with ethylene and/or a C₄-C₁₀ α-olefin in an amount of about 1 mol. % to about 35 mol. %.

Embodiment 11. The method of embodiment 10 wherein the flexible material comprises at least one material selected from the group consisting of paper, paperboard, corrugated cardboard, corrugated box stock, a film, a foil, a metal, a composite material, a textile, and combinations thereof.

Embodiment 12. The method of any of embodiments 10-11 wherein the protective coating is deposited on the flexible material by at least one technique selected from the group consisting of curtain coating, roll coating, flexographic printing, extrusion coating, spray coating, hot melt coating, slot die coating, and combinations thereof.

Embodiment 13. The method of any of embodiments 10-12 wherein the fully refined paraffin wax comprises molecules with carbon numbers from about 20 carbon atoms to about 70 carbon atoms.

Embodiment 14. The method of any of embodiments 10-13 wherein the fully refined paraffin wax has an oil content of less than about 0.8 wt. % as measured according to ASTM D721-17.

Embodiment 15. The method of any of embodiments 10-14 wherein the fully refined paraffin wax has a flash point (Cleveland open cup) in a range of about 215° C. to about 225° C. as measured according to ASTM D92-18.

Embodiment 16. The method of any of embodiments 10-15 wherein the fully refined paraffin wax has a kinematic viscosity at 100° C. (KV100) in a range of about 4.5 mm2/s to about 7.0 mm2/s as measured according to ASTM D445-23.

Embodiment 17. The method of any of embodiments 10-16 wherein the fully refined paraffin wax has a needle pen test penetration at 25° C. in a range of about 15 mm to about 17 mm as measured according to ASTM D1321-16a.

Embodiment 18. The method of any of embodiments 10-17 wherein the fully refined paraffin wax wherein the fully refined paraffin wax has a needle pen test penetration at 25° C. in a range of about 16 mm to about 18 mm as measured according to ASTM D1321-16a.

Embodiment 19. A composition for producing a protective coating on a flexible material comprising: a fully refined paraffin wax comprising straight chain normal paraffin hydrocarbons in an amount of about 60 wt. % or more by weight of the fully refined paraffin wax, wherein the fully refined paraffin wax has a melting point in a range of about 68.5° C. to about 73.5° C. as measured according to ASTM D87-09(2018); and a propylene elastomer in an amount of at least about 3 wt. % of the protective coating wherein the propylene elastomer comprises isotactic propylene repeat units copolymerized with ethylene and/or a C₄-C₁₀ α-olefin in an amount of about 1 mol. % to about 35 mol. %.

Embodiment 20. The composition of embodiment 19 wherein the fully refined paraffin wax comprises molecules with carbon numbers from about 20 carbon atoms to about 70 carbon atoms, wherein the fully refined paraffin wax has an oil content of less than about 0.8 wt. % as measured according to ASTM D721-17, wherein the fully refined paraffin wax has a flash point (Cleveland open cup) in a range of about 215° C. to about 225° C. as measured according to ASTM D92-18, wherein the fully refined paraffin wax has a kinematic viscosity at 100° C. (KV100) in a range of about 4.5 mm2/s to about 7.0 mm2/s as measured according to ASTM D445-23, and wherein the fully refined paraffin wax has a needle pen test penetration at 25° C. in a range of about 15 mm to about 17 mm as measured according to ASTM D1321-16.

To facilitate a better understanding of the present invention, the following examples of certain aspects of some embodiments are given. In no way should the following examples be read to limit, or define, the entire scope of the disclosure.

### Examples

In this Example, a variety of protective coating formulations containing the fully refined paraffin wax and propylene elastomer described above were prepared and compared to an industry standard curtain coating formulation. A typical curtain coating formulation to coat boxes used in agricultural applications includes 80 wt. % wax, 10 wt. % polymer modifier, and 10 wt. % tackifier resin. The polymer modifier typically includes ethylene-vinyl acetate (EVA) which is a copolymer of ethylene and vinyl acetate and was used as a control in this Example.

In this Example, three different types of waxes were tested, linear alpha olefin C26+ wax, Fischer-Tropsch wax, and the fully refined paraffin wax previously described. The waxes were tested in combination with two polymer modifiers, first an EVA polymer comprising ethylene and vinyl acetate and second the propylene elastomer previously described primarily composed of isotactic propylene repeat units with random ethylene distribution.

Table 1 shows the 9 protective coating formulations prepared. LAO C26+ is a linear alpha olefin wax containing C26 and C28 linear alpha olefins. FRP 1 is a fully refined paraffin wax having a melting point of 62.8° C. to 65° C. FRP 2 is a fully refined paraffin wax having a melting point of 68.9° C. to 73.3° C. SPW is a synthetic paraffin wax consisting of linear alkane molecules polymerized from natural gas via Fischer-Tropsch synthesis and having a melting point of 70° C. to 72° C. and has 99% linear paraffins and has a dense crystal packing resulting in a rigid and brittle wax. EVA polymer is a copolymer of ethylene and 27.6 wt. % vinyl acetate having a peak melting temperature of 71.1° C. PE 1 is a propylene elastomer comprising isotactic propylene repeat units with 6 wt. % random ethylene distribution. PE 2 is a propylene elastomer comprising isotactic propylene repeat units with 12 wt. % random ethylene distribution. Tackifier is a light color cycloaliphatic hydrocarbon resin with a softening point of 103.4° C., a melt viscosity at 160° C. of 800 mPa·s, and a glass transition temperature of 52° C. HDPE is a high density polyethylene modifier.

TABLE 1

| | | | | | | | | | |
|---|---|---|---|---|---|---|---|---|---|
| Formulation | 1 | 2 | 3 (control) | 4 | 5 | 6 | 7 | 8 | 9 |

Waxes

| | | | | | | | | | |
|---|---|---|---|---|---|---|---|---|---|
| LAO C26+ | 70 | | | | | | | 40 | 10 |
| FRP 1 | | 70 | | | | | | | |
| FRP 2 | | | 70 | | 70 | 70 | | | |
| SPW | | | | 70 | | | 70 | | |

Polymer

| | | | | | | | | | |
|---|---|---|---|---|---|---|---|---|---|
| EVA Polymer | 10 | 10 | 10 | 10 | | | | | |
| PE 1 | | | | | 10 | | | 40 | 70 |
| PE 2 | | | | | | 10 | 10 | | |

Tackifier

| | | | | | | | | | |
|---|---|---|---|---|---|---|---|---|---|
| Tackifier | 10 | 10 | 10 | 10 | 10 | 10 | 10 | 10 | 10 |

Modifier

| | | | | | | | | | |
|---|---|---|---|---|---|---|---|---|---|
| HDPE | 5 | 5 | 5 | 5 | 5 | 5 | 5 | 5 | 5 |
| Microcrystalline wax | 5 | 5 | 5 | 5 | 5 | 5 | 5 | 5 | 5 |
| Total | 100 | 100 | 100 | 100 | 100 | 100 | 100 | 100 | 100 |

Each of the protective coating formulations was prepared and tested for flexibility. All components were pre-weighed and thereafter the wax was melted and then combined with the other materials. After all the materials were fully melted, the melt was placed into a preheated heating mantle to be blended. Each melted formulation was mixed with a high speed mixer for 2 to 4 minutes and then placed back into the oven for 30 minutes to eliminate any bubbles. Thereafter, the formulations were poured into silicon mold strips and allowed to congeal. The strips were allowed to completely set over 24 hours and then removed from the mold.

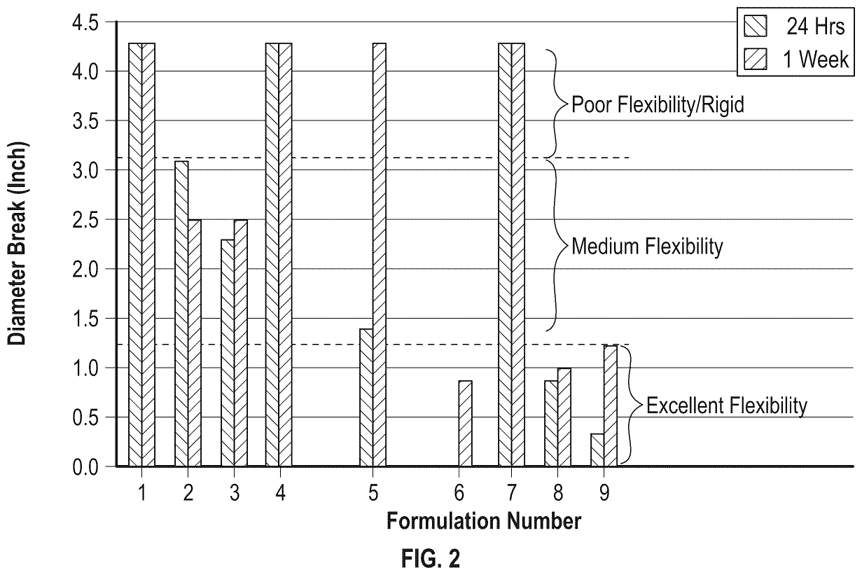

The diameter at break test was performed by folding 3 specimen strips over cylindrical pipes with different diameters (4.3 inch, 2.5 inch, 1.9 inch, 1.6 inch, 1 inch, and 0.8 inch) starting with largest diameter in a temperature-controlled environment (25° C.+/−2° C.) and recording the diameter at which test specimen breaks or cracks. The test was repeated again after 1 week. The results of the diameter at break test are shown in FIG. 2.

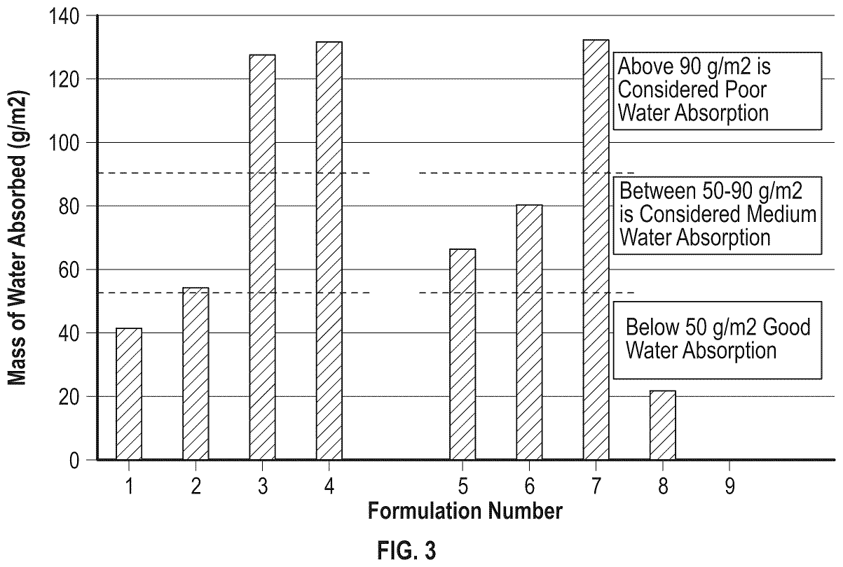

Each of the formulations was subjected to water absorption testing according to ASTM E96 (Cobb test). The results of the water absorption test are shown in FIG. 3.

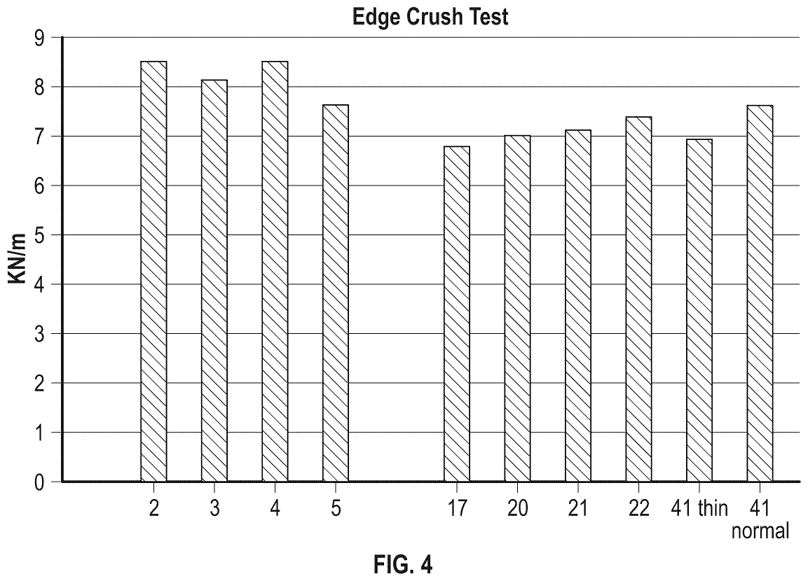

Each of the formulations was subjected to edge crush testing according to ISO 3037:2013, corrugated fiberboard determination of edgewise crush resistance. The results of the edge crush testing are shown in FIG. 4.

The flexibility was tested at 24 hours and at 1 week. It was observed from the data shown in FIG. 2 that compositions 6, 8, and 9 have the best flexibility as each demonstrated less than 1.25 inches diameter at break. It was further observed that protective coating formulation 6, which included the fully refined paraffin wax having a melting point of 68.9° C. to 73.3° C. in an amount of 70 wt. % and 10 wt. % PE 2 having 12 wt. % ethylene, had the best flexibility at less than 0.9 inches (22.86 mm) at breaking. It was further observed that formulation 8 containing 40 wt. % LAO C₂₆+ and 40 wt. % PE 1 having 6 wt. % ethylene had good flexibility. It was further observed that formulation 9 having primarily polymer PE 1 in an amount of 70 wt. % and 10 wt. % LAO 26+ also had good flexibility.

It was observed that as little as 10 wt. % of PE 2 containing 12 wt. % ethylene added to FRP 2 results in increased flexibility as in formulation 6. Correspondingly, formulation 3 control had 10 wt. % of EVA polymer added to FRP 2 which only had medium flexibility. Replacing the FRP 2 with SPW as in formula 4 resulted in a formulation with poor flexibility.

Additionally, a 100 wt. % FRP 2 sample was tested for flexibility. It was observed that the sample had poor flexibility with all samples breaking at a maximum diameter of 4.3 inches after 24 hours and 1 week. Each of the polymers EVA polymer, PE 1, and PE 2 were individually tested and each demonstrated excellent flexibility and did not break after 24 hours and 1 week. Of all samples tested, only one predominantly wax based (>50 wt. %) formulation (sample 6) had good flexibility. It was additionally observed that formulation 6 had good water absorption properties absorbing 80 g/m² as compared to the formulations containing wax and EVA polymer (formulation 4 and 5). It was additionally observed that formulation 6 had improved edge crush resistance as compared to formulations containing wax and EVA polymer (formulation 4 and 5).

Additional formulations were prepared according to Table 2 and tested for diameter at break. It was observed that formulation 10a did not break during testing. It was further observed that removing the polyethylene wax and microwax improved flexibility.

TABLE 2

| Formulation | 10 | 10a | 10b | 10c |
|---|---|---|---|---|
| FRP 2 | 70 | 70 | 70 | 70 |
| PE 2 | 10 | 10 | 10 | 10 |
| Tackifier | 10 | 10 | 10 | 10 |
| HDPE | 5 | | 5 | |
| Microwax | 5 | | | 5 |
| Total | 100 | 90 | 95 | 95 |
| Average diameter @ | 0.8 | 0 | 1.5 | 1.1 |
| which specimen breaks | | | | |

While the disclosure has been described with respect to a number of embodiments and examples, those skilled in the art, having benefit of this disclosure, will appreciate that other embodiments can be devised which do not depart from the scope and spirit of the disclosure as disclosed herein. Although individual embodiments are discussed, the present disclosure covers all combinations of all those embodiments.

While compositions, methods, and processes are described herein in terms of “comprising,” “containing,” “having,” or “including” various components or steps, the compositions and methods can also “consist essentially of” or “consist of” the various components and steps. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the disclosure, additionally, they do not exclude impurities and variances normally associated with the elements and materials used.

All numerical values within the detailed description are modified by “about” the indicated value, and take into account experimental error and variations that would be expected by a person having ordinary skill in the art.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

What is claimed is:

1. A flexible packaging comprising:
a flexible material; and
a protective coating disposed on the flexible material, wherein the protective coating comprises:
a fully refined paraffin wax comprising straight chain normal paraffin hydrocarbons in an amount of about 60 wt. % or more by weight of the fully refined paraffin wax, wherein the fully refined paraffin wax has a melting point in a range of about 68.5° C. to about 73.5° C. as measured according to ASTM D87-09(2018); and
a propylene elastomer in an amount of at least about 3 wt. % of the protective coating wherein the propylene elastomer comprises isotactic propylene repeat units copolymerized with ethylene and/or a C₄-C₁₀ α-olefin in an amount of about 1 mol. % to about 35 mol. %.

2. The flexible packaging of claim 1 wherein the flexible material comprises at least one material selected from the group consisting of paper, paperboard, corrugated cardboard, corrugated box stock, a film, a foil, a metal, a composite material, a textile, and combinations thereof.

3. The flexible packaging of claim 1 wherein the fully refined paraffin wax comprises molecules with carbon numbers from about 20 carbon atoms to about 70 carbon atoms.

4. The flexible packaging of claim 1 wherein the fully refined paraffin wax has an oil content of less than about 0.8 wt. % as measured according to ASTM D721-17.

5. The flexible packaging of claim 1 wherein the fully refined paraffin wax has a flash point (Cleveland open cup) in a range of about 215° C. to about 225° C. as measured according to ASTM D92-18.

6. The flexible packaging of claim 1 wherein the fully refined paraffin wax has a kinematic viscosity at 100° C. (KV100) in a range of about 4.5 mm²/s to 7.0 mm²/s as measured according to ASTM D445-23.

7. The flexible packaging of claim 1 wherein the fully refined paraffin wax has a needle pen test penetration at 25° C. in a range of about 15 mm to about 17 mm as measured according to ASTM D1321-16a.

8. The flexible packaging of claim 1 wherein the fully refined paraffin wax has a needle pen test penetration at 25° C. in a range of about 16 mm to about 18 mm as measured according to ASTM D1321-16a.

9. The flexible packaging of claim 1 wherein the fully refined paraffin wax has a number average molecular weight of about 475 g/mol to about 495 g/mol and has a weight average molecular weight of about 505 g/mol to about 525 g/mol.

10. A method for producing a flexible packaging comprising:
depositing a protective coating on a flexible material, wherein the protective coating comprises:
a fully refined paraffin wax comprising straight chain normal paraffin hydrocarbons in an amount of about 60 wt. % or more by weight of the fully refined paraffin wax, wherein the fully refined paraffin wax has a melting point in a range of about 68.5° C. to about 73.5° C. as measured according to ASTM D87-09(2018); and
a propylene elastomer in an amount of at least about 3 wt. % of the protective coating wherein the propylene elastomer comprises isotactic propylene repeat units copolymerized with ethylene and/or a C₄-C₁₀ α-olefin in an amount of about 1 mol. % to about 35 mol. %.

11. The method of claim 10 wherein the flexible material comprises at least one material selected from the group consisting of paper, paperboard, corrugated cardboard, corrugated box stock, a film, a foil, a metal, a composite material, a textile, and combinations thereof.

12. The method of claim 10 wherein the protective coating is deposited on the flexible material by at least one technique selected from the group consisting of curtain coating, roll coating, flexographic printing, extrusion coating, spray coating, hot melt coating, slot die coating, and combinations thereof.

13. The method of claim 10 wherein the fully refined paraffin wax comprises molecules with carbon numbers from about 20 carbon atoms to about 70 carbon atoms.

14. The method of claim 10 wherein the fully refined paraffin wax has an oil content of less than about 0.8 wt. % as measured according to ASTM D721-17.

15. The method of claim 10 wherein the fully refined paraffin wax has a flash point (Cleveland open cup) in a range of about 215° C. to about 225° C. as measured according to ASTM D92-18.

16. The method of claim 10 wherein the fully refined paraffin wax has a kinematic viscosity at 100° C. (KV100) in a range of about 4.5 mm²/s to about 7.0 mm²/s as measured according to ASTM D445-23.

17. The method of claim 10 wherein the fully refined paraffin wax has a needle pen test penetration at 25° C. in a range of about 15 mm to about 17 mm as measured according to ASTM D1321-16a.

18. The method of claim 10 wherein the fully refined paraffin wax wherein the fully refined paraffin wax has a needle pen test penetration at 25° C. in a range of about 16 mm to about 18 mm as measured according to ASTM D1321-16a.

19. A composition for producing a protective coating on a flexible material comprising:
a fully refined paraffin wax comprising straight chain normal paraffin hydrocarbons in an amount of about 60 wt. % or more by weight of the fully refined paraffin wax, wherein the fully refined paraffin wax has a melting point in a range of about 68.5° C. to about 73.5° C. as measured according to ASTM D87-09(2018); and
a propylene elastomer in an amount of at least about 3 wt. % of the protective coating wherein the propylene elastomer comprises isotactic propylene repeat units copolymerized with ethylene and/or a C₄-C₁₀ α-olefin in an amount of about 1 mol. % to about 35 mol. %.

20. The composition of claim 19 wherein the fully refined paraffin wax comprises molecules with carbon numbers from about 20 carbon atoms to about 70 carbon atoms, wherein the fully refined paraffin wax has an oil content of less than about 0.8 wt. % as measured according to ASTM D721-17, wherein the fully refined paraffin wax has a flash point (Cleveland open cup) in a range of about 215° C. to about 225° C. as measured according to ASTM D92-18, wherein the fully refined paraffin wax has a kinematic viscosity at 100° C. (KV100) in a range of about 4.5 mm²/s to about 7.0 mm²/s as measured according to ASTM D445-23, and wherein the fully refined paraffin wax has a needle pen test penetration at 25° C. in a range of about 15 mm to about 17 mm as measured according to ASTM D1321-16.
